(19) United States
(12) Patent Application Publication
(10) Pub. No.: US 2006/0115179 A1
(43) Pub. Date: Jun. 1, 2006

(54) Operation device for video data

(75) Inventor: Ken Ito, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/289,532

(22) Filed: Nov. 30, 2005

(30) Foreign Application Priority Data
Nov. 30, 2004 (JP) 2004-347747

(51) Int. Cl. G06K 9/40; G06K 9/36

(52) U.S. Cl. 382/275; 382/233

(57) ABSTRACT

A video file containing video data and file information is read from a storage medium. A processing amount determination section determines the amount of processing required by a process of decoding the video data from the file information. A decoding section decodes the video data on the basis of the file information. A processing amount determination section determines the contents of processing to be performed by operation sections according to the amount of processing required to decode the video data. The operation sections performs operations on the decoded video data according to the determined contents of processing.

### CROSS-REFERENCE TO RELATED APPLICATIONS

This application is based upon and claims the benefit of priority from prior Japanese Patent Application No. 2004-347747, filed Nov. 30, 2004, the entire contents of which are incorporated herein by reference.

### BACKGROUND OF THE INVENTION

1. Field of the Invention

The present invention relates to an operation device for video data which performs operations for noise elimination, picture quality improvement, etc. on video data through the use of software-based processing.

2. Description of the Related Art

With optical disk devices, such as DVD players, etc., which decode and play back compressed video data stored on storage media such as DVDs, hard disks, etc., such image processing as reduces noise and improves image quality is implemented in hardware. U.S. Pat. No. 6,466,625 discloses the arrangement of a noise reduction circuit applied to optical disk devices. The hardware implementation of image processing allows processing to be performed at high speed; thus, phenomena, such as drop frames, etc., little occur.

With information processors, such as personal computers, image processing, such as noise reduction, image quality improvement, etc., on video data is implemented in software. In the case of software implementation, processes that can be processed at substantially the same time are limited by the capability of CPUs. Performing complicated (high-performance) noise reduction and image quality improvement processing on video data which has been decoded at a low rate and is relatively poor in quality allows its image quality to be improved. The complicated noise reduction and image quality processing on video data which has been decoded at a high rate and relatively good in quality may cause disadvantages such as drop frames, etc.

### BRIEF SUMMARY OF THE INVENTION

In playing back a video file through software-based processing, the CPU processing time (the amount of processing) required to decode that video file is determined in accordance with its transfer rate and frame size. When the amount of required decoding time is decided to be relatively small, more complicated operation processing is performed as postprocessing after the decode processing.

Operation processes suitable for each video file can be preferentially performed with given priority, allowing the CPU processing power to be used efficiently and picture quality to be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of an operation device for video data according to an embodiment of the present invention;

FIG. 2 is a flowchart illustrating the overall operation of the video data operation device shown in FIG. 1;

FIG. 3 is a functional block diagram illustrating a software implementation of the operation unit shown in FIG. 1;

FIGS. 4A, 4B, 4C and 4D show the ratios of the amounts of processing associated with processes performed on each of video files compressed at different rates;

FIG. 5 shows an example of an image decoded at a low transfer rate and displayed on the display unit; and

FIG. 6 is a flowchart illustrating the operation of the processing amount determination unit shown in FIG. 1.

### DETAILED DESCRIPTION OF THE INVENTION

An embodiment of the present invention will be described hereinafter with reference to the accompanying drawings.

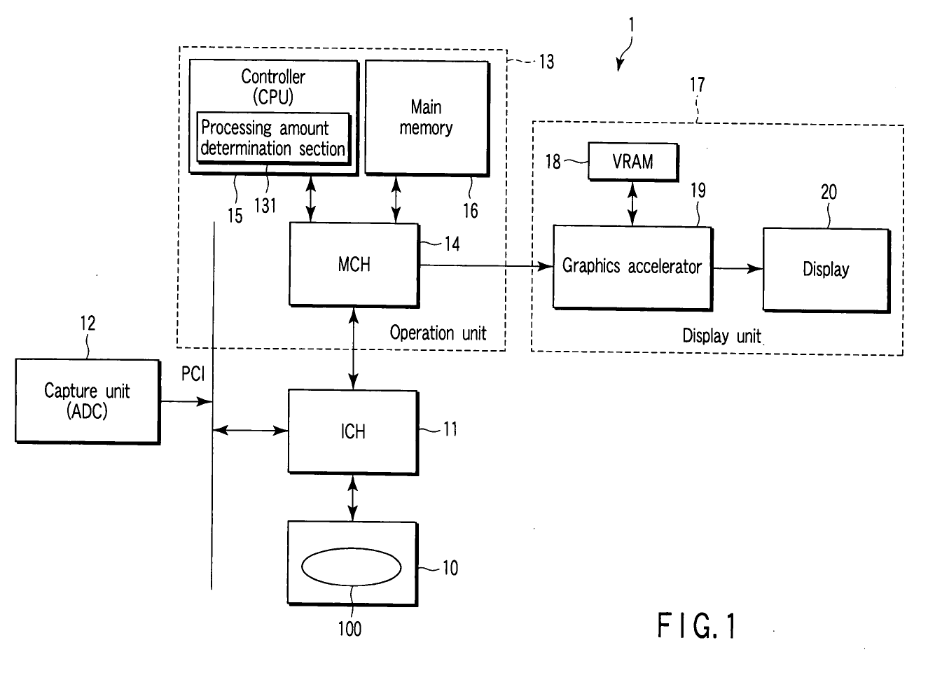

FIG. 1 is a block diagram of a video data operation device according to an embodiment of the present invention. This video data operation device can be implemented through the use of an information processing device such as a personal computer.

The video data operation device 1 includes a disk drive 10, an I/O controller hub (ICH) 11, a capture unit 12, an operation unit 13, and a display unit 17. The disk drive 10 is adapted to record or play back information on or from a storage medium 100 such as a hard disk or DVD. The capture unit 12 is adapted to receive an analog video signal from an external device such as a tuner or VTR and converts it into digital video data, which is, in turn, fed into the video data operation device 1. The I/O controller hub 11 provides the interface between I/O devices, such as the capture unit 12 and disk drive 10, and the video data operation device. The operation unit 13 implements operations for decoding, noise elimination, etc. on the video data output from the I/O controller hub 11 by means of software-based processing. The display unit 11 displays video data processed by the operation unit 13.

The operation unit 13 includes a controller 15 which exercises overall control over the operation processing unit 1, a main memory 16 which stores a program according to the present invention and video data to be operated on, and a memory controller hub (MCH) 14 which controls reading from or writing into the main memory. The controller 15 is comprised of a central processing unit (CPU) and contains a processing amount determination section 131 to be described later. The display unit 17 includes a digital video display unit 20, such as a plasma display or liquid crystal display, and a graphics accelerator 19 which converts decoded video data from the MCH 14 into data compatible with the display unit 20 through the use of a VRAM 18.

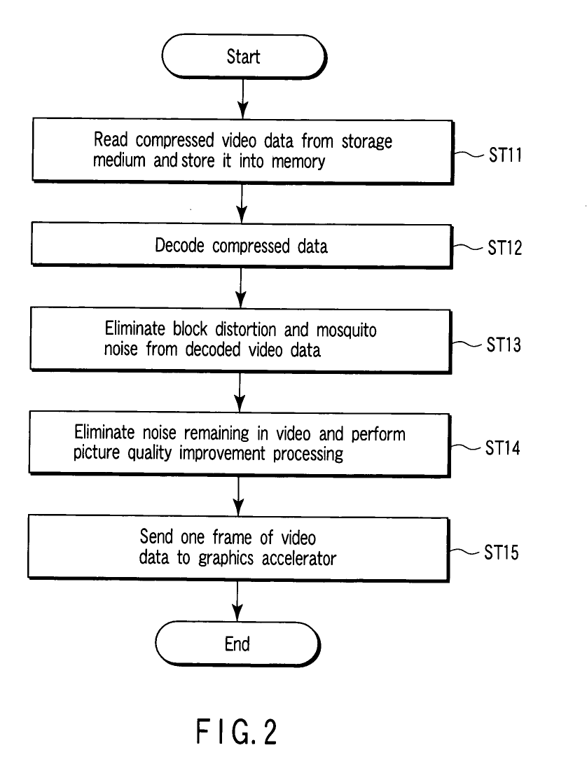

FIG. 2 is a flowchart illustrating the overall operation of the video data operation unit 1. Each step is carried out under the control of the controller 15.

First, in step ST11, the controller 15 reads compressed (encoded) video data stored on the storage medium 100 from the disk drive 10 and writes it into the memory 16 through the ICH 11 and the MCH 14.

Then, in step ST12, the controller 15 decodes the compressed data stored in the memory 16. The compressed data is added with information such as video frame size, transfer rate, etc. The controller 15 decodes the compressed data on the basis of such added information and stores the decoded data into the memory 16 again.

Next, in step ST13, the controller 15 performs postprocessing to remove block distortion and mosquito (ringing) noise caused by compression from the decoded video data. Further, in step ST14, the controller 15 performs processes of eliminating noise (non-correlated high-frequency components) remaining in video data (NR processing) and improving image quality.

Next, in step ST15, the controller 15 sends one frame of video data thus processed to the graphics accelerator 19. After that, the graphics accelerator 19 converts one frame of video data into data compatible with the display unit 20 such as an LCD. The display unit 20 displays video data converted by the graphics accelerator 19.

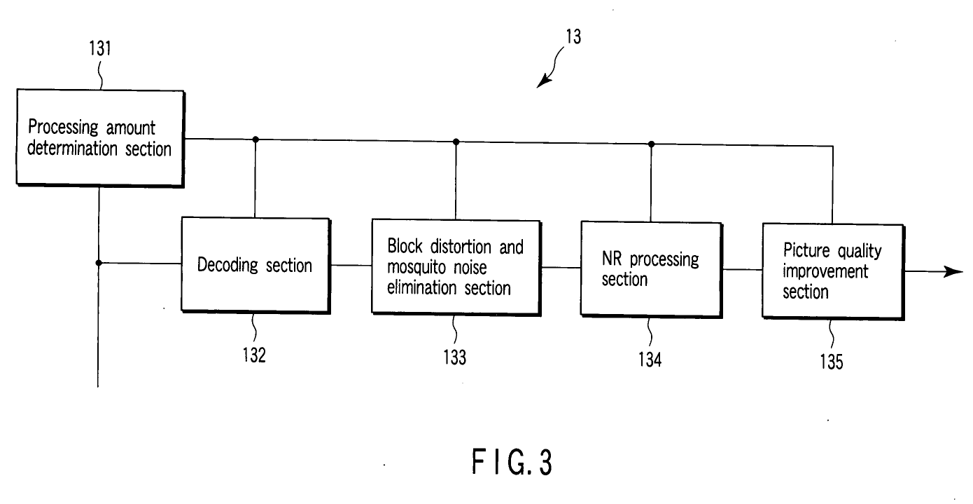

The operation unit 13 will be described in detail below. The operation unit 13 is implemented in software. FIG. 3 is a functional block diagram illustrating a software implementation of the operation unit 13. The operation unit 13 includes a processing amount determination section 131, a decoding section 132, a block distortion and mosquito noise elimination section 133, an NR (noise reduction) section 134, and an image quality improvement section 135.

The decoding section 132 decodes compressed video data. The compressed video data is recorded on the storage medium 100 as a video file. The video file contains file information, such as video frame size, transfer rate at decode time, etc., in addition to the compressed video data. The decoding section 132 decodes the compressed video data on the basis of the file information.

The block distortion and mosquito noise elimination section 133 eliminates block distortion and mosquito noise contained in the video data decoded by the decoding section 132.

The block distortion and an anti-block-distortion filter will be explained hereinafter. The video compression is performed in units of blocks of 8×8 pixels. In playing back video data compressed once, blocks may be displayed with different brightness, in which case a grid-like pattern will be viewed. This pattern is the block distortion.

As the anti-block-distortion filter, use is made of a filter (LPF) which, in the presence of a difference in pixel level between blocks, can smooth the level difference. However, simply filtering compressed video data would degrade inherent picture information. It is therefore required to decide whether picture information is present in the periphery and accordingly change how to subject compressed video data to a filtering operation (filtering range). To decide the block distortion or picture edges, it is also required to examine information in the periphery.

The quality of picture information after being processed depends on how finely (precisely) those processes have been performed. How finely those processes are to be performed is determined in view of the operation processing amount associated with other processes in the operation unit 13. This determination is made by the processing amount determination section 131 as will be described later.

Next, the mosquito noise (ringing noise) and an anti-mosquito-noise filter will be explained. The mosquito noise is noise which appears on the periphery of characters and edges. The noise which moves with time is referred to as the mosquito noise and the noise which is stationary is referred to as the ringing noise. Such noise is caused by the loss of high-frequency components resulting from compression.

As the anti-mosquito-noise filter use is made of a filter which smoothes variations in pixel value on the periphery of image edges. However, when the image contains high-frequency signals, the image quality will be degraded; thus, it is required to change the way of filtering (filtering range, etc.). In this case as well, the quality of the picture information after being processed depends on how finely the picture information has been examined. How finely the picture information is to be examined is determined in view of the operation processing amount associated with other processes in the operation unit 13 as described above.

Next, the NR section 134 will be explained. The NR section 134 eliminates noise other than noise to be eliminated by the block distortion/mosquito noise elimination section 133. The noise to be eliminated by the NR section 134 is other than noise associated with picture information. The block distortion or mosquito noise is caused by compression and differs from the noise to be eliminated by the NR section 134.

The NR section 134 recognizes components with no interpixel correlation to be noise and eliminates them. The NR section 134 eliminates components (high-frequency components) recognized to be noise in view of interfield, interframe, and interline correlation as in the case of three-dimensional NR.

Next, the image quality improvement section 135 will be described. The image quality improvement section 135 implements such a process of increasing image quality as generally performed in TV or the like in software. The improvement of image quality is made by sharpness processing, motion-adaptive IP conversion, black and white expansion, etc.

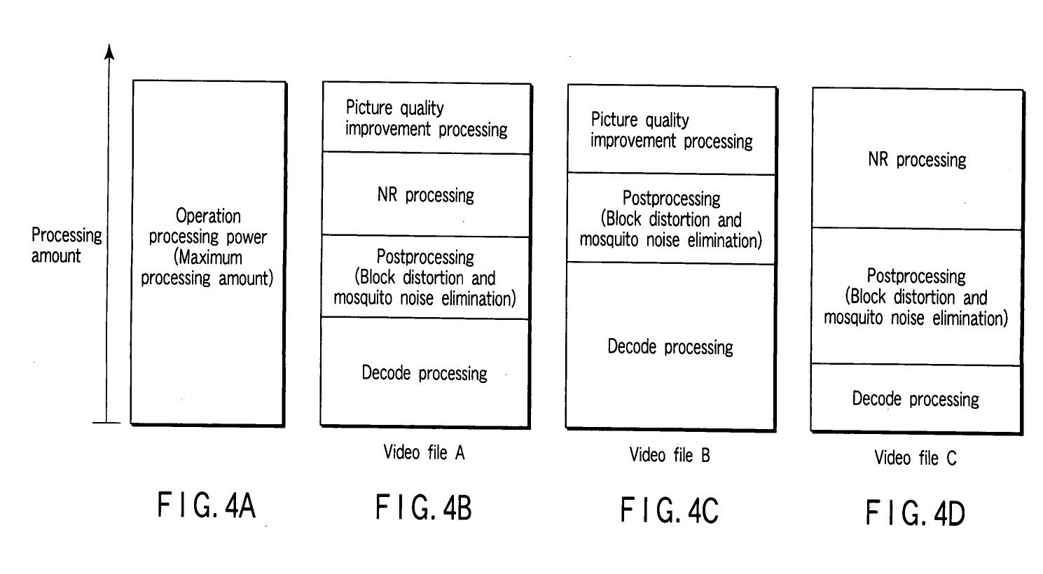

FIGS. 4A, 4B, 4C and 4D show the ratios of the amounts of operation processing (hereinafter simply referred to as the processing amount) associated with processes performed on each of video files compressed at different rates.

In the present invention, as shown in FIG. 4, the contents of processing to be performed by the operation unit 13 are made to vary according to the video frame size and/or the transfer rate at the time of decoding compressed video data. The operation processing power per unit of time (maximum processing amount) of the operation unit 13 is limited as shown in FIG. 4A. How much the limited operation power of the operation unit is to be allocated to each of the operation processes in order to improve video quality is determined properly according to the frame size and the transfer rate. The operation processes determined to be more proper are preferentially performed.

In decoding compressed video data, information concerning its frame size and transfer rate can be known from file information. The processing time is proportional to the amount of data to be processed, which is proportional to the frame size or transfer rate. That is, if the frame size or transfer rate is small, the processing amount for decoding is small. Thus, the processing amount by the decoding section 132 can be described in terms of the frame size or transfer rate.

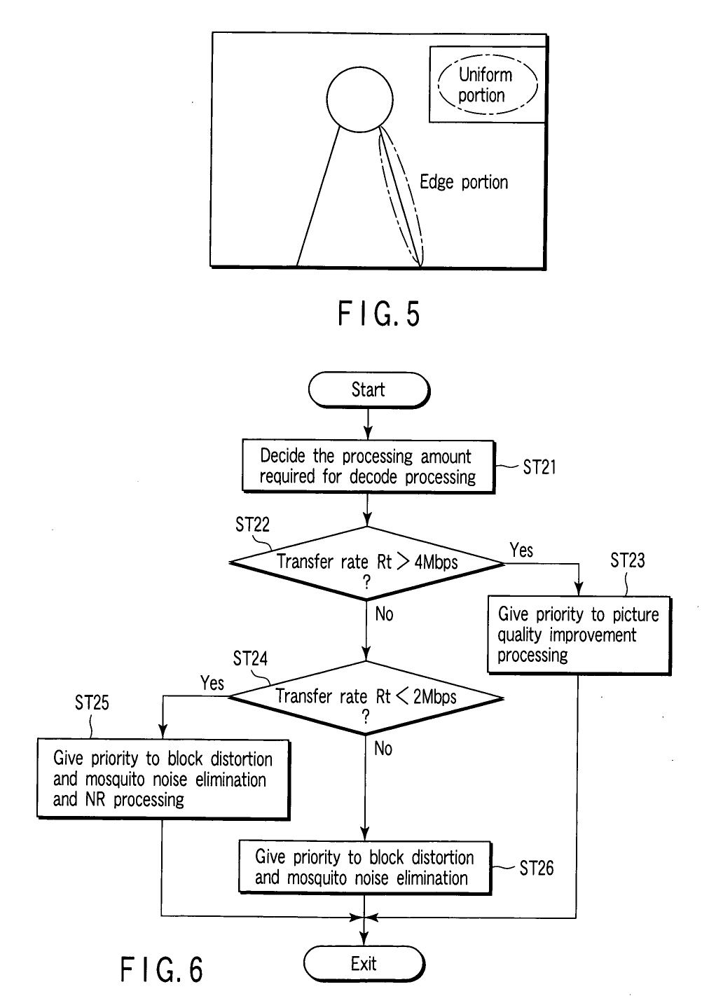

In general, the higher the compression rate of an image (the larger the data reduction amount), the poorer the quality of the decoded (decompressed) image becomes. For video high in compression rate, therefore, such an operation process as allows video of poor quality to be displayed finely is selected. With such a process, it is important to accurately separate video into a video signal component and a noise component in processing. To this end, it is required to increase the processing amount. For example, when such video as shown in FIG. 5 is decoded at a low transfer rate and then displayed on the display unit, mosquito noise is generated in edge portions and block distortion (noise) becomes noticeable in a portion where the pixel level is uniform. Therefore, those noise portions need to be detected with precision to perform effective noise elimination with effective video signal portions being little affected. FIG. 4D shows the allocation of the processing amounts of processes performed by the operation unit 13 on the video file C decoded at a low transfer rate (low picture quality). In this example, the block distortion elimination, mosquito noise elimination and NR processing are given a higher priority than the other processing. The processing amounts of the block noise/mosquito noise elimination section 133, the NR section 134 and the image quality improvement section 135 can be expressed in terms of, for example, the number of processing steps per unit time.

Conversely, with video of good quality (high transfer rate), since noise is little generated, the separation between video and noise requires a simpler operation than with video of poor quality. Therefore, much of the processing power of the operation unit 13, i.e., the computational power of the CPU, can be allocated to image quality improvement processing such as counter emphasis. FIG. 4C shows the allocation of the processing amounts for the video file B to which the image quality improvement processing is given higher priority than the NR processing.

FIG. 6 is a flowchart illustrating the operation of the processing amount determination section 131.

As described previously, the process of decoding a video file containing compressed video data is carried out in accordance with file information contained in that video file. In step ST21, the processing amount determination section 131 determines the amount of processing required for the decoding process from the frame size (the number of pixels in the horizontal direction and the number of pixels in the vertical direction) and/or the transfer rate contained in the file information. In the description which follows, to simplify it, a description is given of a case where the amount of processing required for the decoding process is simply determined on the basis of the transfer rate.

The general compression settings in the standard picture quality mode are such that the frame size is 720×480 pixels and the transfer rate is 4 Mbps. In step ST22, the processing amount determination section 131 determines the amount of processing in each of the processing sections 133, 134 and 135 on the basis of the transfer rate. When the transfer rate Rt is more than 4 Mbps, priority is given to the process by the image quality improvement processing section 135 for the purpose of enhancing the image quality as in the case of the video file B of FIG. 4C (step ST23). That is, with the video file B, a larger processing amount is set than with video files of less than 4 Mbps in transfer rate, with regard to image quality improvement processing.

The transfer rate of video data the frame size of which is 352×480 pixels, half of the frame size 720×480 pixels, is generally less than 2 Mbps. When the transfer rate is less than 2 Mbps (YES in step ST24), block distortion and mosquito noise caused by compression and other noise increase. Therefore, the processing amount determination section 131 gives priority to the processing to be performed by the block distortion/mosquito noise elimination section 133 and the NR processing section 134 as with the video file C of FIG. 4D (step ST25). That is, with the video file C, a larger processing amount is set than with video files of more than 2 Mbps in transfer rate, with regard to block distortion/mosquito noise elimination and NR processing.

When the transfer rate Rt of video data is not more than 4 Mbps but not less than 2 Mbps (NO in step ST24), the block distortion and mosquito noise is generated more easily than with the video file B but less easily than with the video file C. Thus, the processing amount determination section 131 allows the block distortion/mosquito noise elimination section 133, the NR processing section 134, and the image quality improvement processing section 135 to perform their respective processes as in the case of the video file A of FIG. 4B. As can be seen from the foregoing, the processing amount determination section 131 changes the contents of processing to be performed by the operation unit 13 in accordance with the results of determination of the processing amounts.

According to the present invention, as described above, the amounts of processing to be performed by the operation sections 133, 134 and 135 are determined according to the amount of processing required to decode a video file; thus, the processing power of the CPU can be used efficiently to provide high-quality video signals.

If predetermined operation processes are performed on each video file equally, there arises a possibility that video frames may be dropped out because the operation processes can not catch up with display of the frames. In the present invention, however, the amounts of processing to be performed by the operation sections 133, 134 and 135 are determined suitably; thus, effective processing can be performed to provide high-quality video signals.

The postprocessing (block distortion/mosquito noise elimination), the NR processing, or the image quality improvement processing is performed selectively according to the compression transfer rate and the image size, thus allowing high-quality video signals to obtained in an efficient manner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An operation device for video data comprising:
a readout section which reads a video file containing video data and file information from a storage medium;
a judgment section which judges the amount of processing required by a process of decoding the video data from the file information;
a decoding section which decodes the video data read by the readout section;
an operation section which performs operation processing on the video data decoded by the decoding section; and
a determination section which determines the contents of the operation processing to be performed by the operation section according to the amount of processing judged by the judgment section.

2. The device according to claim 1, wherein the operation section includes a noise elimination section which performs noise elimination processing on the video data decoded by the decoding section and an image quality improvement section which performs image quality improvement processing on the video data which has had noise eliminated by the noise elimination section.

3. The device according to claim 2, wherein the determination section determines the amount of processing required for the noise elimination section to eliminate noise and the amount of processing required for the image quality improvement section to improve the image quality on the basis of the amount of processing required by the decoding process.

4. The device according to claim 3, wherein the determination section increases the amount of processing to be performed by the noise elimination section as the amount of processing required by the decoding process becomes smaller.

5. The device according to claim 3, wherein the determination section increases the amount of processing to be performed by the image quality improvement section as the amount of processing required by the decoding process becomes larger.

6. The device according to claim 3, wherein the determination section causes the processing to be performed by the noise elimination section to have priority over the processing to be performed by the image quality improvement section when the amount of processing required by the decoding process is less than a predetermined amount.

7. The device according to claim 3, wherein the noise elimination section includes a section which eliminates noise including block distortion and mosquito noise caused by compression and a section which eliminates components with no interpixel correlation as noise.

8. The device according to claim 1, wherein information required for the judgment section to judge the amount of processing required by a process of decoding the video data includes the transfer rate of the video data.

9. The device according to claim 1, wherein information required for the judgment section to judge the amount of processing required by a process of decoding the video data includes the frame size of the video data.

10. An operation method for video data comprising:
reading a video file containing video data and file information from a storage medium;
judging the amount of processing required by a process of decoding the video data from the file information;
decoding the read video data;
performing operation processing on the decoded video data; and
determining the contents of the operation processing according to the judged amount of processing required to decode the video data.

11. The method according to claim 10, wherein the operation processing includes noise elimination processing performed on the decoded video data and image quality improvement processing performed on the noise-eliminated video data.

12. The method according to claim 11, wherein the determining includes determining the amount of processing required by the noise elimination processing and the amount of processing required by the image quality improvement processing on the basis of the amount of processing required by the decoding process.

13. The method according to claim 12, wherein the determining includes increasing the amount of processing to be performed by the noise elimination processing as the amount of processing required by the decoding process becomes smaller.

14. The method according to claim 12, wherein the determining includes increasing the amount of processing to be performed by the image quality improvement processing as the amount of processing required by the decoding process becomes larger.

15. The method according to claim 12, wherein the noise elimination processing includes a processing of eliminating noise including block distortion and mosquito noise caused by compression and a processing of eliminating components with no interpixel correlation as noise.

16. The method according to claim 10, wherein information required to judge the amount of processing required by a process of decoding the video data includes the transfer rate of the video data.

17. The method according to claim 10, wherein information required to judge the amount of processing required by a process of decoding the video data includes the frame size of the video data.
